(19) United States
(12) Patent Application Publication
(10) Pub. No.: US 2008/0152777 A1
(43) Pub. Date: Jun. 26, 2008

(54) Instant Acidified Milk Beverages

(76) Inventor: Maria del Pilar Cobos, Port Chester, NY (US)

Correspondence Address: FITCH EVEN TABIN & FLANNERY, 120 S. LASALLE STREET, SUITE 1600, CHICAGO, IL, 60603-3406, US

(21) Appl. No.: 11/958,490

(22) Filed: Dec. 18, 2007

Related U.S. Application Data
(60) Provisional application No. 60/871,056, filed on Dec. 20, 2006.

(51) Int. Cl. A23C 9/16

(52) U.S. Cl. 426/588

(57) ABSTRACT

The invention relates to instant acidified milk beverages and methods for producing such instant acidified milk beverages. More specifically, the present invention provides a powdered composition which can be added to a milk product with minimal mixing to produce an instant acidified milk beverage having a smooth texture.

### FIELD OF THE INVENTION

The invention relates to instant acidified milk beverages and methods for producing such instant acidified milk beverages. More specifically, the present invention provides a powdered composition which can be added to a milk product with minimal mixing to produce an instant acidified milk beverage having a smooth texture.

### BACKGROUND OF THE INVENTION

Attempts have been made to provide powdered compositions suitable for mixing with milk or water for the manufacture of non-gelled acidified, milk-product drinks. For example, U.S. Pat. No. 4,450,850 (Jul. 23, 1985) provided a powdered composition that, upon mixing with milk, formed a non-gelled, acidified, milk-product drink without curdling of the milk proteins. The powdered composition contained about 1 to about 9 percent of an edible acid, about 0.5 to about 1.9 percent of an instant cold-water soluble gelatin, about 1 to about 10 percent of an edible natural or modified polysaccharide gum, about 20 to about 90 percent sweetening agents, and an effective amount of flavoring and coloring agents. The beverage was prepared by vigorously mixing (e.g., in a blender at high speed for 10 seconds or in a shaker for an unlisted time) the powdered composition into milk. It was reported that the gelatin included in the powder became attached to the casein in the milk, thereby stabilizing the milk proteins at lower pH; the gum was reportedly used to improve the viscosity and texture of the final beverage product. Attempts to reproduce the work reported in U.S. Pat. No. 4,450,850 by the present inventor were generally unsuccessful.

Accordingly, there remains a need for instant acidified milk beverages and methods for producing such instant acidified milk beverages. There also remains a need to provide a powdered composition which can be added to a milk product with minimal mixing to produce an instant acidified milk beverage having a smooth texture. The present invention provides such beverages, methods, and powdered compositions.

### SUMMARY

The invention relates to instant acidified milk beverages and methods for producing such instant acidified milk beverages. The present invention provides a powdered composition which can be added to a milk product with minimal mixing (e.g., gentle hand stirring with a spoon) to produce an instant acidified milk beverage having a smooth texture. The present invention also provides a method for preparing the powdered composition.

The powdered composition of the present invention can be reconstituted with a liquid (water or milk) and stirred with a spoon with minimal mixture to provide an acidified milk beverage in which the precipitation of casein proteins is minimized through a polysaccharide network apparently associated with guar gum. The powdered composition is admixed dry by managing the order of addition of ingredients and following a two step mixing process as described herein. No liquids are used in the preparation of the powdered compositions of the present invention. The resulting powdered composition has good dispersibility and hydration when added to the liquid. No agglomeration or homogenization steps are required. Stabilizers such as cellulose, starch, pectin, gelatin or other hydrocolloids are needed and preferably none are used.

The powdered compositions of the present invention contain sugar, an artificial sweetener, citric acid, a buffering or acid bite reducing agent (e.g., sodium citrate, potassium citrate, glucono delta lactone, and the like), guar gum, optional flavorants, optional colorants, optional vitamins, minerals, prebiotics, or probiotics, and optional fiber; the powdered compositions of the present invention do not require, and preferably do not contain, any gelatin ingredient. The powdered composition, when added to a liquid milk product (e.g., whole milk, 2% milk, 1% milk, skim milk, and the like), only requires minimal mixing to obtain the desired acidified milk beverage. Preferably the milk is pasteurized and even more preferably pasteurized using an ultra high temperature process.

### DETAILED DESCRIPTION

The invention relates to instant acidified milk beverages and methods for producing such instant acidified milk beverages. The present invention provides a powdered composition which can be added to a milk product with minimal mixing to produce an instant acidified milk beverage having a smooth texture. The present invention also provides a method for preparing the powdered composition.

The powdered compositions of the present invention contain sugar, an artificial sweetener, citric acid, a buffering or acid bite reducing agent (e.g., sodium citrate, potassium citrate, glucono delta lactone, and the like), guar gum, optional flavorants, optional colorants, optional vitamins, minerals, prebiotics, or probiotics and optional fiber; the powdered compositions of the present invention do not require, and preferably do not contain, any gelatin ingredient. The powdered composition, when added to a liquid milk product (e.g., whole milk, 2% milk, 1% milk, skim milk, and the like), only requires minimal mixing to obtain the desired acidified milk beverage. Preferably the milk is pasteurized and even more preferably pasteurized using an ultra high temperature process.

For purposes of this invention, “minimal mixing” is intended to mean hand mixing using a simple hand mixing device such as a spoon; blenders, mechanical mixing devices (e.g., rotator mixers operated by hand or electrical power, shaker devices, and the like) are specifically not required or included in the definition of minimal mixing. Of course, as one skilled in the art will understand, the requirement that only “minimal mixing” is required to obtain the desired acidified milk beverage does not mean that the consumer cannot use more vigorous mixing conditions, but only that such more vigorous mixing conditions or equipment are not needed (or desired). Generally, a homogenous liquid beverage is obtained by such minimal mixing (e.g., hand mixing with a spoon) within about 60 seconds or less, and preferably within about 45 seconds or less. Indeed, one of the major advantages of the present powdered compositions is that only minimal mixing is required.

The powdered compositions of the present invention are prepared by dry blending the granular components (i.e., at least 50 percent and preferably at least about 80 percent of the sugar, all of the citric acid, and all of the buffering or acid bite reducing agent) with the guar gum to form a first homogenous mixture in which the guar gum is evenly distributed throughout. Each of the granular components should have an average particle size of about 150 to about 600 microns, and preferably an average particle size of about 250 to about 300 microns. Blending to form this first homogenous mixture can be carried out using conventional dry blending techniques and equipment (e.g., ribbon blinder and the like). Once a homogenous mixture (i.e., guar gum evenly distributed throughout), the remaining dry ingredients (i.e., artificial sweeteners and optional ingredients plus any of the sugar not incorporated in the first stage), are then mixed therein in a second stage to form a second homogenous mixture. Mixing to form this second homogenous mixture can also be carried out using conventional dry blending techniques and equipment. This second homogenous mixture is the powdered composition of the present invention. Preferably, the dry blending in both the first and second stages are carried out at, or near, ambient temperatures.

There appears to be a number of critical features in both the method of manufacture and selection of ingredients if a satisfactory powdered composition can be obtained. For purposes of this invention, a satisfactory powdered composition is one that can be combined with milk with only minimal mixing to form the desired instant acidified milk beverages of the present invention. The two stage mixing process, as well as the components mixed together in each stage, appears to be critical in preparing the powdered compositions of the present invention. Indeed, mixing all components in a single mixing step results in agglomeration in the powder, thereby resulting in lumps and/or other deficiencies when the powder is mixed with the milk component. Likewise, failure to include all of the granular components in the first mixing stage with the guar gum also produces an unacceptable powder.

The particle size of the granular materials also appears to be critical. As noted above, the average particle sizes of the granular materials should be about 150 to about 600 microns, and preferably about 250 to about 300 microns; preferably there are no particles less than about 100 microns and no particles greater than about 850 microns for the granular materials. Additionally, the ratio of granular materials to guar gum should be in the range of about 13 to about 40 and preferably about 15 to about 35.

The amount of citric acid (and any other pH modifying agents included in the formulation) should be in an amount effective to provide a pH of less than 4.6 in the final acidified beverage. Higher pH values in the resulting acidified beverage will result in unacceptable gel formation. The level of citric acid necessary to ensure pH below 4.7 will generally result in a strong acid flavor or “acid bite.” Thus, a buffering or acid bite reducing agent (e.g., sodium citrate, potassium citrate, glucono delta lactone, and the like) are used to smooth or reduce the acid flavor. The amount of the buffering or acid bite reducing agent can be adjusted to smooth or reduce the acid flavor to an acceptable level, thereby enhancing the flavor profile.

Furthermore, the only type of gum that appears to perform satisfactory in the present invention is guar gum. Attempts to use other gums were not successful. Although not wishing to be limited by theory, it is thought that the guar gum forms a polysaccharide network that can stabilize the milk proteins when the powdered composition of this invention is added to milk to form the desired instant acidified milk beverages of the present invention. It is not clear why other gums do not appear to work. Although only guar gum appears to work, guar gums having different viscosity characteristics can be used. By selection of the particular guar gum, the viscosity of the resulting acidified milk beverage can be controlled to the desired range. Generally, the viscosity of the resulting acidified beverage should be such as to provide a slightly thick but drinkable beverage (i.e., generally approaching the viscosity of a conventional “smoothie” or drinkable yogurt drink). Generally, the viscosity will preferably be in the range of about 150 to about 400 centipoises, and more preferably in the range of about 180 to about 250 centipoises. Examples of suitable guar gum for use in the present invention include, but are not limited to, HiGum 55-1 from Hindustan Gums of India, TICprestested® Guar NT Bland 200 HV from TIC Gums of Delaware, and Guar Gum Supercol GF from Hercules of Delaware.

The powdered compositions of the present invention will generally contain the following ingredients; both general and preferred ranges are given in the Table below.

| Ingredient | General Range (%) | Preferred Range (%) |
|---|---|---|
| Sugar | 40 to 90 | 70 to 85 |
| Citric Acid | 6 to 18 | 7 to 15 |
| Buffering or Acid Bite | 0.01 to 3 | 0.6 to 1.6 |
| Reducing Agent | | |
| Guar Gum | 1 to 10 | 3.5 to 8 |
| Artificial Sweeteners | 0.001 to 0.6 | 0.15 to 0.4 |
| Calcium Fortification Agent | 0 to 35 | 2 to 15 |
| Emulsifiers | 0 to 3 | 0 to 1 |
| Flavorings | 0 to 5 | 0.8 to 2.5 |
| Colorants | 0 to 1 | 0.001 to 0.1 |

Of course, optional ingredients can be included in the powdered compositions of this invention so long as they do not adversely affect the ability of the acidified milk beverage to be prepared by addition of the powdered compositions to milk or water or otherwise impair the organoleptic properties. Thus, for example, emulsifiers, flavorings, colorants, calcium fortification agents, vitamins, minerals, probiotics, prebiotics, fiber, and the like can be incorporated into the present powdered compositions. Suitable calcium fortification agents include, but are not limited to, calcium lactate, tricalcium phosphate, and the like.

Although the present invention is mainly directed to powdered compositions which are to be added to a milk product, it can also be used to prepare a similar powdered composition containing milk powders (e.g., agglomerated skim milk powder, full fat or reduced fat milk powder, and the like) which can then be reconstituted in water to form a similar acidified milk beverage. In such a case, the milk powders are added to the homogenous mixture (i.e., guar gum evenly distributed throughout) in the second stage along with the other dry ingredients.

Although this invention is mainly directed to preparation of instant acidified milk beverages, the technology can be used to prepare other types of instant food products which can be quickly and easily prepared by the consumer at a desired time by either mixing into a milk product or water as appropriate. Such products include, but are not limited to, salad dressings, sauces, soups, and the like. Of course, flavorings should be incorporated into the powdered compositions to achieve the desired product flavor profile.

The Examples that follow are intended to illustrate, and not to limit, the invention. All percentages and ratios used herein are by weight, unless otherwise indicated. All reference cited in the present specification are hereby incorporated by reference.

### EXAMPLE 1

A peach flavored powdered composition containing the following ingredients was prepared:

| Ingredient | Amount (%) |
|---|---|
| Sugar | 75.0 |
| Citric Acid | 7.86 |
| Sodium Citrate | 1.43 |
| Guar Gum | 5.00 |
| Glucono Delta Lactone | 0.36 |
| Calcium Lactate | 4.64 |
| Monohydrate | |
| Peach Pulp | 1.98 |
| Aspartame | 0.22 |
| Potassium Acesulfame | 0.028 |
| Sodium Saccharine | 0.1 |
| Sodium Cyclamate | 0.002 |
| Tricalcium Phosphate | 1.26 |
| Peach Flavorings | 2.0 |
| Colorants | 0.06 |

The granular materials (i.e., sugar, citric acid, and sodium citrate) were blended with the guar gum in a plow mixer for about 3 to about 4 minutes to obtain a first homogenous dry mixture wherein the guar gum was evenly distributed throughout. The average particle sizes for the sugar, citric acid, and sodium citrate used in the first stage mixing were 300, 250, and 250 microns, respectively. The guar gum used was HiGum 55-1 from Hindustan Gums. The ratio of granular materials to guar gum was about 13.2.

All other ingredients were then blended with the first homogenous dry mixture in a ribbon mixture (duration about 10 to about 12 minutes) to form the powdered composition. Approximately 14 g of the powdered composition was then added to about 200 ml cold milk (full fat; ultrahigh temperature pasteurized) and mixed into the milk with gentle hand stirring with a spoon. A smooth homogenous acidified milk beverage was obtained within about 45 seconds of gentle stirring. The homogenous acidified milk beverage had a pH of about 4.32, a viscosity of about 218 centipoises, and about 180 total calories. The acidified milk beverage had an excellent peach flavor and a smooth texture.

### EXAMPLE 2

A strawberry flavored powdered composition containing the following ingredients was prepared:

| Ingredient | Amount (%) |
|---|---|
| Sugar | 77.7 |
| Citric Acid | 7.86 |
| Sodium Citrate | 1.43 |
| Guar Gum | 5.00 |
| Glucono Delta Lactone | 0.36 |
| Calcium Lactate | 4.22 |
| Monohydrate | |
| Strawberry Juice Solids | 0.86 |
| Aspartame | 0.5 |
| Potassium Acesulfame | 0.016 |
| Tricalcium Phosphate | 1.14 |
| Strawberry Flavorings | 0.78 |
| Colorants | 0.02 |

The granular materials (i.e., sugar, citric acid, and sodium citrate) were blended with the guar gum in a plow mixer for about 3 to about 4 minutes to obtain a first homogenous dry mixture wherein the guar gum was evenly distributed throughout. The average particle sizes for the sugar, citric acid, and sodium citrate used in the first stage mixing were 300, 250, and 250 microns, respectively. The guar gum used was HiGum 55-1 from Hindustan Gums. The ratio of granular materials to guar gum was about 17.4.

All other ingredients were then blended with the first homogenous dry mixture in a ribbon mixture (duration about 10 to about 12 minutes) to form the powdered composition. Approximately 14 g of the powdered composition was then added to about 200 ml cold milk (full fat; ultrahigh temperature pasteurized) and mixed into the milk with gentle hand stirring with a spoon. A smooth homogenous acidified milk beverage was obtained within about 45 seconds of gentle stirring. The homogenous acidified milk beverage had a pH of about 4.57, a viscosity of about 378 centipoises, and about 180 total calories. The acidified milk beverage had an excellent strawberry flavor and a smooth texture.

### EXAMPLE 3

A strawberry flavored powdered composition was prepared using the same procedures and having the same ingredients except that agglomerated skim milk powder was incorporated into the composition during second stage mixing. A single serving sized powdered composition effectively contained 14 g of the powdered composition of Example 2 and 19 g of agglomerated skim milk powder. The resulting powdered composition (33 g total) was then mixed with 200 ml water with gentle hand stirring with a spoon. A smooth homogenous acidified milk beverage was obtained within about 45 seconds of gentle stirring. The homogenous acidified milk beverage had a pH of about 4.32, an estimated viscosity of about 400 centipoises, and about 120 total calories. The acidified milk beverage had an excellent strawberry flavor and a smooth texture.

### EXAMPLE 4

A number of strawberry flavored powdered compositions were prepared using essentially the same procedures and ingredients as in Example 2, except that the amounts of the various ingredients were varied to provide different ratios of granular material to gum and different pH values when combined with either 200 ml cold full fat milk or 2% milk. The ratio of granular material to gum varied from about 13.6 to about 25.1 and the pH of the final milk beverage ranged from about 4.2 to about 4.6. All prepared samples of the acidified milk beverage had an excellent strawberry flavor and a smooth texture similar to that observed in Example 2.

### CONTROL EXAMPLE 5

A strawberry flavored powdered composition was prepared using essentially the same ingredients at the same levels as in Example 2. A single stage mixing procedure (i.e., all ingredients initially mixed together) was used rather than the two stage mixing procedure as described in Example 2. When the powdered composition was added to milk, the powder did not disperse very well and it resulted in an unsatisfactory product.

### CONTROL EXAMPLE 6

A number of strawberry flavored powdered compositions were prepared using essentially the same procedures and ingredients as in Example 2, except that the amounts of the various ingredients were varied to provide different ratios of granular material to gum and different pH values when combined with either 200 ml cold full fat milk or 2% milk. The ratio of granular material to gum varied from about 9 to about 12.5 and the pH of the final milk beverage ranged from about 4.5 to about 6.0. When added to milk, the powdered compositions having a ratio below 13 and/or a pH greater than 4.6 caused the milk to curdle.

It will be understood that various changes in the details, materials, and arrangements of formulations and ingredients, which have been herein described and illustrated, in order to explain the nature of the method, may be made by those skilled in the art within the principle and scope of the embodied method as expressed in the appended claims.

What is claimed is:

1. A powdered composition for preparing an instant acidified milk beverage using a liquid milk product, said composition comprising sugar, artificial sweetener, citric acid, a buffering or acid bite reducing agent, guar gum, and optional flavorants and colorants, wherein the powdered composition is prepared by dry mixing the sugar, citric acid, and the buffering or acid bite reducing agent with the guar gum in a first mixing step to form a homogenous mixture wherein the guar gum is distributed evenly throughout the homogenous mixture, and then dry mixing all remaining ingredients into the homogenous mixture in a second mixing step; wherein the sugar, citric acid, and the buffering or acid bite reducing agent are granular components having average particle sizes of about 150 to about 600 microns; wherein the ratio of the granular components to the guar gum is about 13 to about 40 in the powdered composition; wherein the powdered composition can be incorporated into the liquid milk product with minimal mixing to form an acidified milk beverage with a pH less than 4.6, a viscosity of about 150 to about 400 centipoises, and good organoleptic properties.

2. The powdered composition as defined in claim 1, wherein the ratio of granular components to guar gum is about 20 to about 35.

3. A powdered composition for preparing an instant acidified milk beverage using water, said composition comprising sugar, artificial sweetener, citric acid, a buffering or acid bite reducing agent, guar gum, a powdered milk powder, and optional flavorants and colorants, wherein the powdered composition is prepared by dry mixing the sugar, citric acid, and the buffering or acid bite reducing agent with the guar gum in a first mixing step to form a homogenous mixture wherein the guar gum is distributed evenly throughout the homogenous mixture, and then dry mixing all remaining ingredients into the homogenous mixture in a second mixing step; wherein the sugar, citric acid, and the buffering or acid bite reducing agent are granular components having particle sizes of about 150 to about 600 microns; wherein the ratio of the granular components to the guar gum is about 13 to about 40 in the powdered composition; wherein the powdered composition can be incorporated into water with minimal mixing to form an acidified milk beverage with a pH less than 4.6, a viscosity of about 150 to about 400 centipoises, and good organoleptic properties.

4. The powdered composition as defined in claim 1, wherein the ratio of granular components to guar gum is about 20 to about 35.

5. A method for preparing a powdered composition for preparing an instant acidified milk beverage, said method comprising
(1) dry blending sugar, citric acid, and a buffering or acid bite reducing agent with guar gum in a first blending step unit the guar gum is homogenously distributed throughout to form a homogenous mixture, and
(2) dry blending artificial sweeteners, optional flavorants and colorants into the homogenous mixture to form the powdered composition,
wherein the sugar, citric acid, and the buffering or acid bite reducing agent are granular components having particle sizes of about 150 to about 600 microns;
wherein the ratio of the granular components to the guar gum is about 13 to about 40 in the powdered composition; wherein the powdered composition can be incorporated into a liquid milk product with minimal mixing to form an acidified milk beverage with a pH less than 4.6, a viscosity of about 150 to about 400 centipoises, and good organoleptic properties.

6. The powdered composition as defined in claim 1, wherein the ratio of granular components to guar gum is about 20 to about 35.

7. A method for preparing a powdered composition for preparing an instant acidified milk beverage, said method comprising
(1) dry blending sugar, citric acid, and a buffering or acid bite reducing agent with guar gum in a first blending step unit the guar gum is homogenously distributed throughout to form a homogenous mixture, and
(2) dry blending artificial sweeteners, dry milk powder, optional flavorants and colorants into the homogenous mixture to form the powdered composition,
wherein the sugar, citric acid, and buffering or the buffering or acid bite reducing agent are granular components having particle sizes of about 150 to about 600 microns; wherein the ratio of the granular components to the guar gum is about 13 to about 40 in the powdered composition; wherein the powdered composition can be incorporated into water with minimal mixing to form an acidified milk beverage with a pH less than 4.6, a viscosity of about 150 to about 400 centipoises, and good organoleptic properties.

8. The method as defined in claim 7, wherein the ratio of granular components to guar gum is about 20 to about 35.
